(19) United States
(12) Patent Application Publication
(10) Pub. No.: US 2023/0334690 A1
(43) Pub. Date: Oct. 19, 2023

(54) WILD OBJECT LEARNING AND FINDING SYSTEMS AND METHODS

(71) Applicant: FLIR Unmanned Aerial Systems ULC, Vancouver (CA)

(72) Inventors: Jun Wang, Waterloo (CA); Jun Zhang, Waterloo (CA)

(21) Appl. No.: 18/337,710

(22) Filed: Jun. 20, 2023

Related U.S. Application Data
(63) Continuation of application No. PCT/US2021/065251, filed on Dec. 27, 2021.
(60) Provisional application No. 63/132,455, filed on Dec. 30, 2020.

(51) Int. Cl. G06T 7/20; G06V 10/764; G06T 7/70; G06V 10/25

(52) U.S. Cl. CPC G06T 7/70; G06T 7/20; G06V 10/25; G06V 10/764; G06T 2207/20081; G06T 2207/20084; G06V 2201/07

(57) ABSTRACT

A detection device, such as an unmanned vehicle, is adapted to detect and classify an object in sensor data comprising at least one image using a dual-task classification model comprising predetermined object classifications and learned object classifications, determine user interest in the detected object, communicate object detection information to a control system based at least in part on the determined user interest in the detected object, receive learned object classification parameters based at least in part on the communicated object detection information, and update the dual-task classification model with the received learned object classification parameters.

### CROSS-REFERENCE FOR RELATED APPLICATIONS

This application is a continuation of International Patent Application No. PCT/US2021/065251 filed Dec. 27, 2021 and entitled “SYSTEMS AND METHODS FOR LEARNING AND FINDING OBJECTS IN-THE-WILD,” which claims priority to and the benefit of U.S. Provisional Pat. Application No. 63/132,455 filed Dec. 30, 2020 and entitled “WILD OBJECT LEARNING AND FINDING SYSTEMS AND METHODS,” all of which are incorporated herein by reference in their entirety.

### TECHNICAL FIELD

One or more embodiments of the present disclosure relate generally to machine learning systems and, more particularly, for example, to systems and methods for training a machine learning system for object detection, including real-time detection and training of objects that have not been predefined.

### BACKGROUND

In the field of image processing, there is an ongoing need for efficient and reliable ways to detect and classify objects of interest within a field of view (e.g., a scene) of an imaging device. Traditional “smart cameras” combine a machine vision imaging component and a single board computer running rules-based image processing software. These systems are used for simple problems like barcode reading or identifying a particular feature of a known object.

Machine leaning systems have been implemented to provide more complex image analysis. In one approach, various images of an object of interest are collected into a training dataset for training a neural network to classify the object. The training images may be generated with a camera capturing images of the object at various angles and in various setting. A training dataset often includes thousands of images for each object classification, and can be time consuming, expensive and burdensome to produce and update. The trained neural network may be loaded on a server system that receives and classifies images from imaging devices on a network. In some implementations, the trained neural network may be loaded on an imaging system.

Simplified machine vision and image classification systems are available, but such systems are not capable of running robust trained neural networks and are difficult to adapt to various end-use scenarios. In practical implementations, limitations on memory, processing, communications, and other system resources often lead system designers to produce classification systems directed to particular tasks. A neural network may be trained for particular classification tasks and implemented to allow for real time operation within the constraints of the system. However, in the field the trained system may encounter new objects of interest that were not included in the training data, and thus these new objects will not be accurately detected or classified.

In view of the foregoing, there is a continued need for improved object detection and classification solutions, including systems and methods for detecting and classifying new objects identified during operation.

### SUMMARY

Various systems and methods are provided for object detection and classification. In some embodiments, a system comprises an unmanned vehicle adapted to traverse a search area and generate sensor data associated with an object that may be present in the search area, the unmanned vehicle comprising a first logic device configured to detect and classify the object in the sensor data, communicate object detection information to a control system when the unmanned vehicle is within a range of communications of the control system, and generate and store object analysis information when the unmanned vehicle is not in communication with the control system. The object analysis information is generated to facilitate detection and classification of the detected object.

In various embodiments, the unmanned vehicle comprises an unmanned ground vehicle (UGV), and unmanned aerial vehicle (UAV), and/or an unmanned marine vehicle (UMV), and further comprises a sensor configured to generate the sensor data, the sensor comprising a visible light image sensor, an infrared image sensor, a radar sensor, and/or a Lidar sensor. The first logic device may be further configured to execute a trained neural network configured to receive a portion of the sensor data and output a location of an object in the sensor data and a classification for the located object, wherein the trained neural network is configured to generate a confidence factor associated with the classification. In addition, the first logic device may be further configured to construct a map based on generated sensor data.

The system may also include a control system configured to facilitate user monitoring and/or control of the unmanned vehicle during operation including a display screen, a user interface, and a second logic device configured to receive real-time communications from the unmanned vehicle relating to detected objects, access the stored object analysis information during a period when the unmanned vehicle is in communication range of the control system, use at least a portion of the object analysis information to facilitate detection and classification of the detected object, and update object detection information in accordance therewith. The second logic device may be further configured to generate a training data sample from the updated object detection information for use in training an object classifier; retrain the object classifier using a dataset that includes the training data sample; and determine whether to replace a trained object classifier with the retrained object classifier, the determination based at least in part on a comparative accuracy of the trained object classifier and the retrained object classifier in classifying a test dataset. In addition, the second logic device may be further configured to, if it is determined to replace the trained object classifier with the retrained object classifier, download the retrained object classifier to the unmanned vehicle to replace the trained object classifier; and add the training data sample to the training dataset. Other embodiments of systems and methods are also covered by the present disclosure.

The scope of the disclosure is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an example object detection system workflow, in accordance with one or more embodiments.

FIG. 2 illustrates an example operation of a wild object learning and finding (WOLF) system, in accordance with one or more embodiments.

FIG. 3 illustrates a data flow example for an operation of a WOLF system, in accordance with one or more embodiments.

FIG. 4 illustrates example image processing in a dual branch detection system, including a WOLF detection branch, in accordance with one or more embodiments.

FIG. 5 illustrates example image processing components in a WOLF system, in accordance with one or more embodiments.

FIG. 6 illustrates an example object detection system, in accordance with one or more embodiments.

FIG. 7 illustrates an example operation of a wild object location finder object detection system, in accordance with one or more embodiments.

FIG. 8 illustrates an example remote device configured for processing of object detection data, in accordance with one or more embodiments.

FIG. 9 illustrates an example control station configured for processing of object detection data, in accordance with one or more embodiments.

FIG. 10 illustrates an example neural network training process, in accordance with various embodiments of the present disclosure.

FIG. 11 illustrates a validation process for the neural network of FIG. 4, in accordance with various embodiments of the present disclosure.

FIG. 12 illustrates an example operation of object detection and classification in a remote device, in accordance with one or more embodiments.

FIG. 13 illustrates an example operation of object detection and classification training in a control system, in accordance with one or more embodiments.

Embodiments of the disclosure and their advantages are best understood by referring to the detailed description that follows. It should be appreciated that like reference numerals are used to identify like elements illustrated in one or more of the figures.

### DETAILED DESCRIPTION

Aspects of the present disclosure generally relate to object detection and classification. Object detection, which deals with identifying and locating objects of certain classes in the image, has been widely used. However, the current mainstream usage scenario is that application providers predefine the categories to be discovered, and it is difficult for users to easily customize the categories they are interested in. The present disclosure describes a practical live training solution and a novel dual-task object detector called a wild object learner and finder (WOLF) to allow users to detect other objects of interest that are not defined by the predefined categories. In various embodiments, WOLF learns objects that may be interesting to users from tracking targets and is able to find new objects automatically (e.g., within 15 minutes in many implementations).

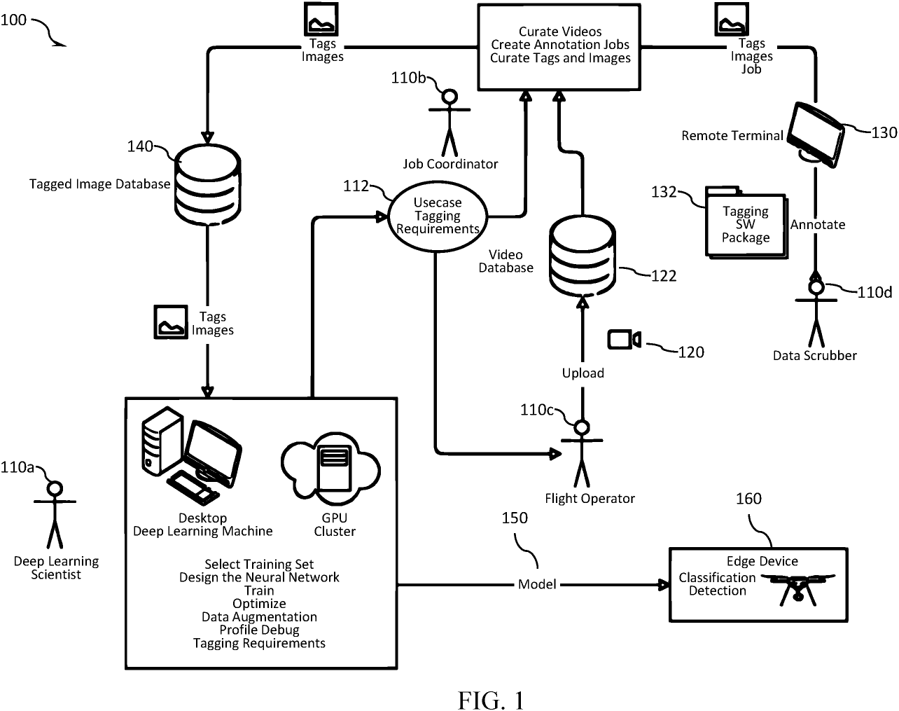

Referring to FIG. 1, an example object detection system workflow 100 will be described in accordance with one or more embodiments. The object detection system workflow 100 begins with a system definition in which one or more people design and build the system for a particular classification task. The creation of trained model 150 for use on an edge device 160 (e.g., an unmanned aerial vehicle (UAV)) can take a lot of time and effort by multiple users. For example, a deep learning scientist 110a may define a neural network, hardware requirements and data requirements for the classification task. The deep learning scientist 110a may, for example, select one or more training sets for training the model 150, train and optimize the neural network, augment the data (e.g., expand the training dataset by modifying training images in the training dataset), profile and debug the model, and define tagging requirements for the training dataset.

A job coordinator 110b coordinates the creation of the training dataset for one or more use cases, in accordance with use case tagging requirements 112, including curating videos, creating annotation jobs (e.g., tags images job), and curating tags and images for use in the dataset. A flight operator 110c operates a UAV with a video camera 120 to capture and upload sample video (e.g., to a video database) of objects of interest in accordance with one or more use cases. The flight operator 110c may instruct the UAV to capture image of a variety of objects, at various distances, angles and viewing conditions for use in the training dataset. The video may also include actual video from surveillance or other UAV missions that represent real world object detection scenarios.

One or more data scrubbers 110d at a remote terminal 130 interact with an image/video tagging software program 132 to identify and classify objects of interest in the uploaded video and to a video database. In many workflows, image tagging is a manual process that is time consuming and labor intensive. The tagged images are provided to a tagged image database 140 for use by the deep learning scientist 110a to train and validate the trained model 150 for deployment on an edge device 160, such as a UAV that performs object detection and classification of captured images. The deep learning scientist 110a may operate a dedicated deep learning machine with specialized hardware, such as a cluster of graphics processing units (GPU) optimized for matrix multiplication tasks used in the neural network detection system.

It will be appreciated that the workflow of FIG. 1 is an example and that other workflows and/or modifications of the workflow 100 may be implemented. For example, the manual tasks performed by users 110a, 110b, 110c, and 110d, may be performed by one or more people, the video images may be captured by a video camera 120 mounted on an aerial vehicle, terrestrial vehicle, marine vehicle, a fixed structure, by a handheld video camera, or other implementation. The system components (e.g., remote terminal 130, video database 122, tagged image database 140, and the systems used by the deep learning scientist 110a) may be located at one location on one device, distributed across multiple devices, and/or distributed across multiple locations that include one or more networks and/or cloud systems.

Using the workflow 100 of FIG. 1, it is difficult for a user of the edge device 160 to customize the model to detect new objects or perform new classifications they are interested in. To add a new object, for example, the job coordinator 110b will instruct the flight operator 110c to capture video image of the desired objects and the data scrubber 110d to tag the captured images. The deep learning scientist 110a will then add the new tagged images to the training dataset for the model 150 to retrain the model 150. The trained model 150 can then be uploaded to the edge device 160 for deployment in the field.

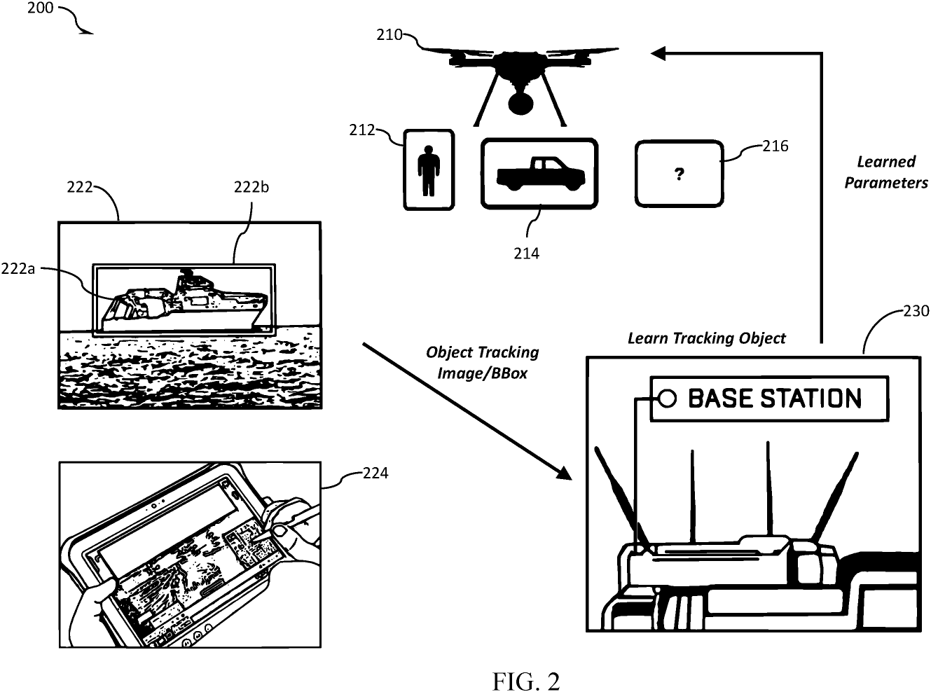

Referring to FIG. 2, an operation of a WOLF object detection system will now be described, in accordance with one or more embodiments. The WOLF system 200 allows users to detect new objects of interest that were not predefined in the trained object detection and classification model (e.g., model 150 of FIG. 1). In various embodiments, the WOLF system learns objects that may be interesting to users from tracking targets and is able to find new objects automatically, without the time consuming and labor-intensive workflows previously described.

As illustrated, a user operating a terminal 224 controls the flight of a UAV 210, which includes image capture components and a trained object detection and classification model. Although a UAV is illustrated, it will be appreciated that the WOLF object detection system may operate with any system configured to provide captured images and/or video to the trained object detection and classification model. The UAV 210 is configured to capture video and detect and classify one or more objects, such a person 212 or a terrestrial vehicle 214. The WOLF system 200 is also configured to learn from images of unknown objects 216. For example, the object detection components of the UAV 210 may automatically detect an object in an image and identify the object using a bounding box, such as the boat 222a and bounding box 222b in image 222. In some embodiments, the user operating the terminal 224 may identify an object of interest by manually or automatically tracking an object using the UAV 210, by identifying an object in an image through a user interface on the terminal, or through other methods. For example, the UAV may include user designated target tracking components allowing the user to track objects of interest. In various embodiments, the system 200 learns from the tracked objects that it was unable to classify and automatically updates the trained object detection and classification model. In some embodiments, the system 200 includes a base station in communication with the UAV 210 that facilitates an analysis of the tracked objects and learning of new model parameters. In some embodiments, the base station 230 includes wireless communications components configured to communicate with the UAV 210 and/or user terminal 224, and processing components configured to perform the learning and model updating processes described herein.

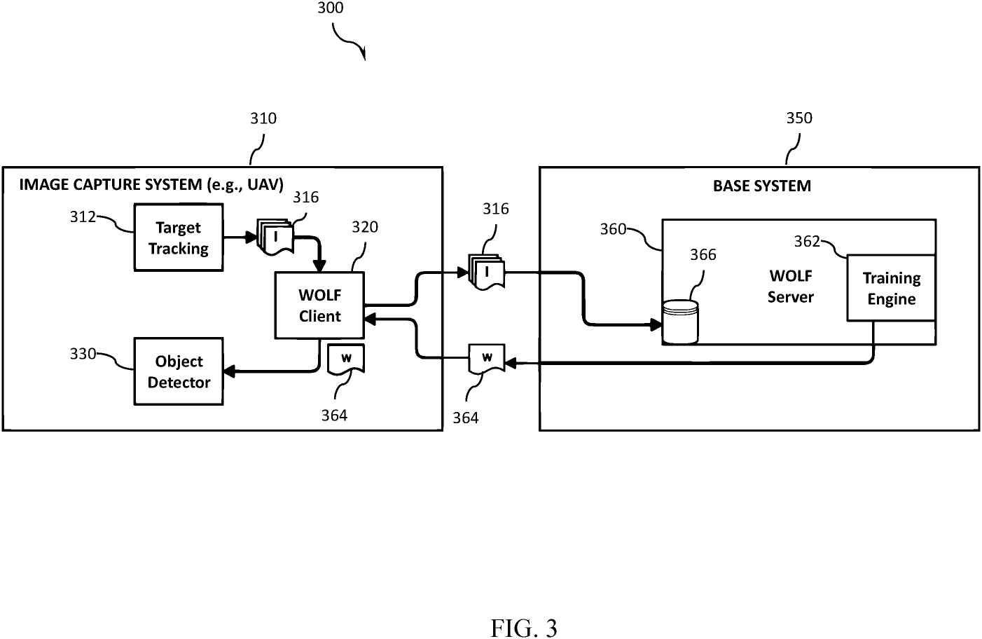

An example operation of a WOLF system will now be described in further detailed with reference to FIG. 3. The WOLF system 300 includes an image capture system 310, such as the UAV 210 of FIG. 2, and a base station 350 (such as base station 230). The image capture system 310 includes an object detector 330 configured to receive the captured images and detect and classify objects therein using a trained neural network, and a WOLF client 320 that is operable to save captured images, which may include bounding boxes for detected objects, and upload those images to a WOLF server 360 at the base station 350.

In the illustrated embodiment, the image capture system 310 includes target tracking components 312, such as user designated target tracking, operable to track a target object in a captured image. For example, the user may view an image captured by a UAV, identify an object in the image to track, and instruct the UAV to track the object. In some embodiments, the WOLF client 320 is configured to save images associated with user designated target tracking and upload those images to the WOLF server 360. In other embodiments, the WOLF client 320 may be configured to identify and upload other subsets of images that contain objects of interest to the user. In some embodiments, a learning rate is configured by the user which may include defining how the system identifies objects of interest (e.g., user identified, user designated tracking, time spent with object in view, etc.) and when to upload captured images to the WOLF server for processing (e.g., after tracking an object a number n times).

The Wolf server 360 includes a training engine 362 and an image storage 366. The image storage is configured to receive and store images 316 identified by the target tracking components, for example, through the WOLF client 320. The training engine 362 is configured to learn new parameters for the classification model using the new object images and update the object detector 330 using the learned parameters 364. The updated training model will then be operable to detect and classify the new object.

In one embodiment, the WOLF training engine 362 comprises two GPUs with mini-batch size 128 for 120 epochs. The parameters for the predefined detection categories are frozen when training. In one embodiment, the learning rate is set to 0.016 initially, then it decreases by the cosine learning rate annealing schedule, and the weight decay is set to 5e-4 and the momentum is set to 0.9. In cosine learning rate annealing, the learning rate decays with a cosine shape (the learning rate of epoch t (t <= 120) set to 0.5 ∗ lr ∗ (cos(π ∗ t/120) + 1).

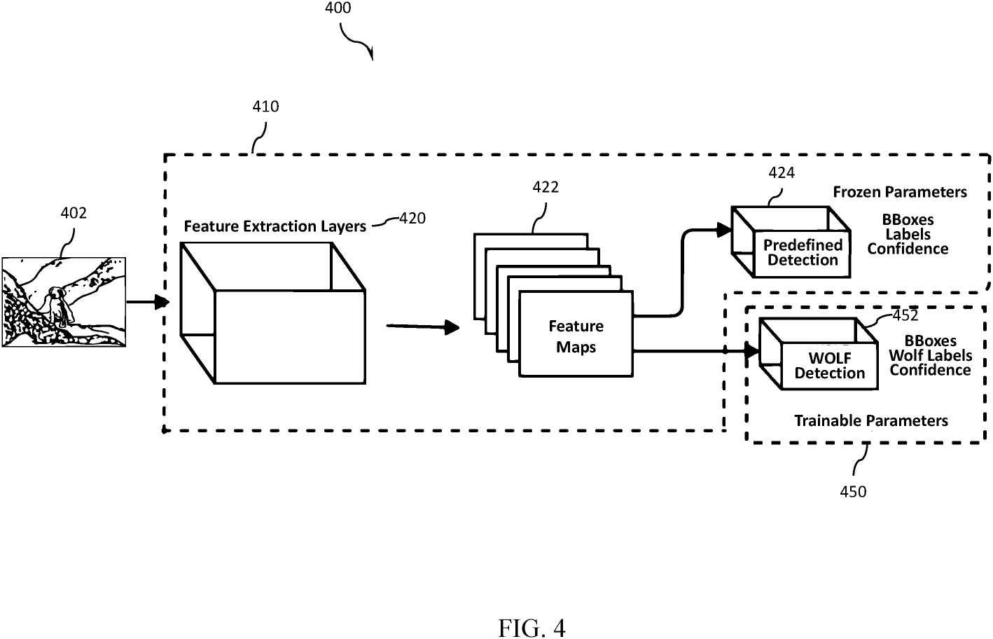

In various embodiments, the WOLF is implemented as dual branch object detector with fixed parameters and trainable parameters. Referring to FIG. 4, an embodiment of a dual branch object detector will now be described. The object detector 400 includes a trained neural network model 410 that is configured to detect and classify one or more objects from capture images (such as image 402). The trained neural network model 410 is configured to receive an input image 402, extract features from the image at stage 420, construct feature maps 422, and output, at stage 424, bounding boxes, classification labels and confidence factors for predefined object classifications.

The feature maps 422 are also provided to a WOLF branch 450 that outputs bounding boxes, Wolf labels, and confidence factors for objects learned through the processes described herein. In this embodiment, the trainable WOLF detector 452 shares computational resources with the pretrained object detector (e.g., over 90% of the computations may be shared), but processing follows a second branch for detecting objects of interest. Parameters for the predefined categories may be frozen when live training the WOLF branch.

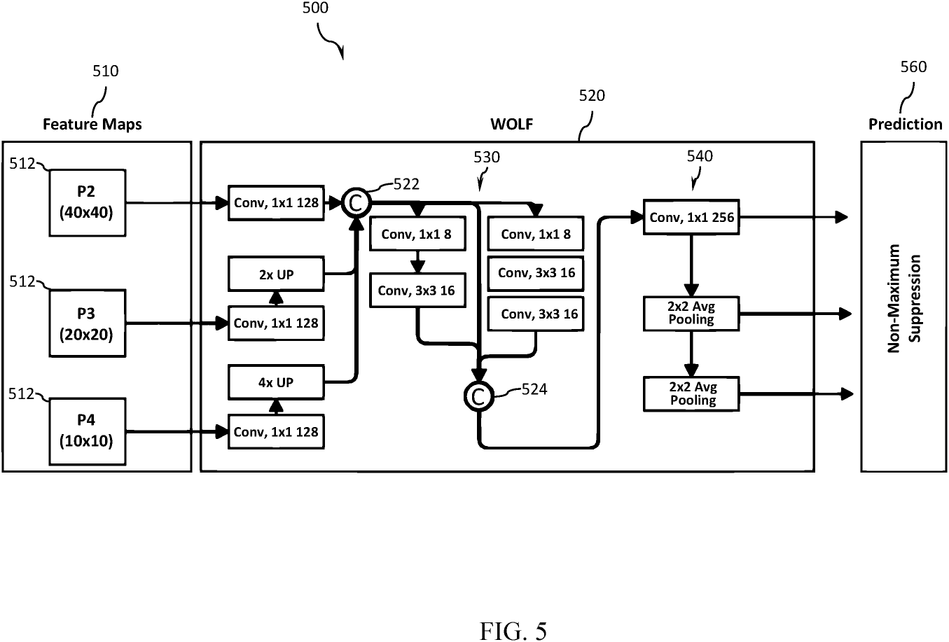

FIG. 5 illustrates example image processing components in a WOLF system, in accordance with one or more embodiments. The WOLF branch 500 receives feature maps 510 from the pooling layers of the trained object detection model. The pooling layers 512 include down sampled feature maps describing features present in the feature map. The WOLF processing components 520 include a 1 by 1 convolution operation what is applied to each input feature map to reduce the dimension to 128 channels. These features are then resized to the same size (e.g., through upscaling functions) and are concatenated at 522. The concatenated features include both the detailed information used for locating the object and the high semantic information used for classification. A 2-way dense layer 530 is then applied to the concatenated features to get different scales of receptive fields that are concatenated at 524. In one path the layer uses a 3 by 3 kernel size, and in the other path the layer uses two stacked 3 by 3 convolutions to learn visual patterns for large objects. These features are then converted to the task specific features for prediction at 540 by a 1 by 1 convolution operation and the average pooling operations. The prediction 560 is computed using non-maximum suppression or other suitable methodology.

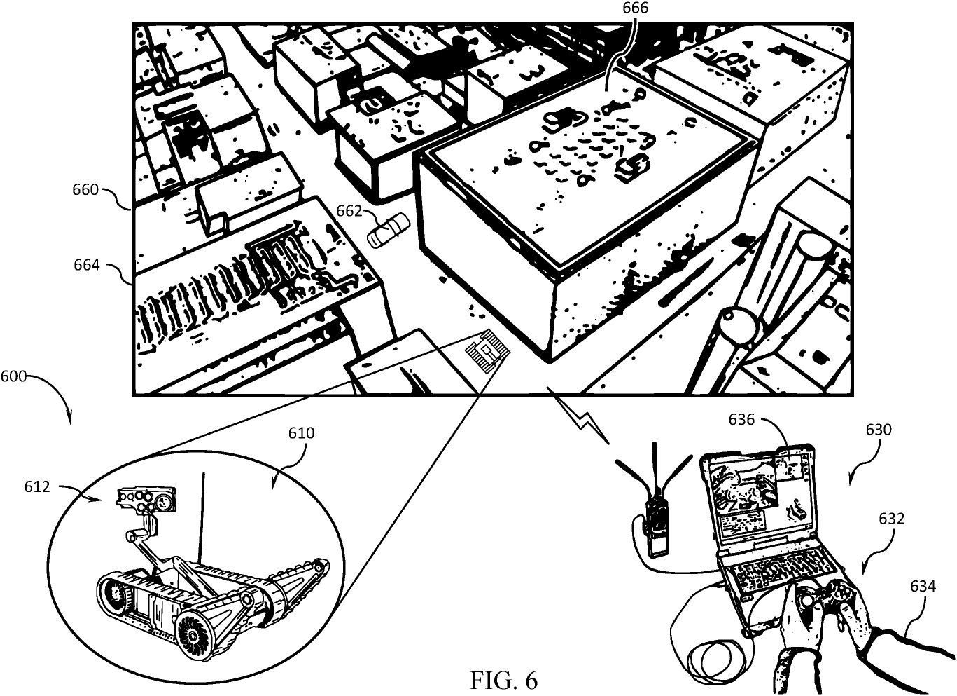

Example embodiments and implementations of WOLF systems and method will now be described in further detail with respect to FIGS. 6-13. Embodiments include a system where objects are detected in images, which detection may be supplemented by object data from other sensor components and processed based on a determination of user interest in the object. The system may operate in real-time or be configured to record and play back image and object data that was captured by the system during the detection of the object, providing the control station user with an ability to see objects and provide an indication of interest. The user interface may include a real-time virtual reality, augmented reality or other interface capable of displaying data from an image capture system (e.g., a UAV, UGV, UMV, etc.) to the user making it easier for the user to show interest in the object.

In various embodiments, a device captures sensor data from an environment and performs object detection, classification, localization and/or other processing on the captured data. For example, a system may include an unmanned ground vehicle (UGV) configured to sense, classify and locate objects in its environment, while in wireless communication with a control station that facilitates additional processing and control. The UGV may include a runtime object detection and classification module that includes a trainable WOLF processing branch. In some embodiments, the system is configured to capture the visible images of the object, but also position and location information from one or more sensors, such as point cloud data from a light detection and ranging (Lidar) system, real-world coordinate information from a global positioning satellite (GPS) system, and/or other data from other sensor systems, that applies to the scenario.

The object detection systems and methods described herein may be used in various object detection contexts. For example, the system may include a robot (e.g., a UGV) that senses aspects of an environment, detects objects in the sensed data, and stores related object data in a database and/or map of those object detections. The system may include a UAV that displays video to the user in real-time, allowing the user to identify objects of interest, track objects of interest, surveil, or perform other functions.

In some embodiments, the detection of objects is performed using a trained artificial intelligence system, such as a convolutional neural network (CNN) classifier, that outputs a location of a box around detected objects in a captured image. In some cases, further detail may be desired, such as an understanding of the location of a reference point on the detected object. The systems described herein include a dual branch classifier that includes a pretrained model and a trainable, WOLF classifier, that learns based on user interest in one or more objects. In various embodiments, the classifier also outputs a probability indicating a confidence factor in the classification.

Referring to FIG. 6, an example object detection system 600 will now be described, in accordance with one or more embodiments. A robot 610 with imaging and other sensors 612 is controlled by a controller 630 with user interface 632 with an interactive display 636 that commands the robot 610 to explore autonomously, such as through a real-world location 660. While the robot 610 is exploring autonomously, it may lose communication and the with the controller 630 for a period of time (e.g., due to distance, obstruction, interference, etc.), during which the controller 630 receives no or partial information from the robot 610. While the robot 610 is out of range of the controller 630, it continues to collect data about the location 660. In some embodiments, the robot 610 is configured to detect an object of interest (e.g., car 662) and place that object in a map that the robot 610 is generating and storing in memory. The robot 610 may continue searching for and detecting objects of interest, such as building 664 and building 666, before returning to within communications range of the controller 630.

After the controller 630 re-establishes communications with the robot 610, the controller 630 accesses the updated map, which includes the new objects that have been detected, including their positions, type, and confidence level as determined by the object detection and classification model in the robot 610. In some embodiments, a real-time VR view of the 3D map and other telemetry from the robot 610 is utilized to make it easier for the user 634 to control the robot 610 using the controller 630 and/or indicate an interest in one or more objects. The user input may be used to train a WOLF model for the detections and then the updated WOLF model is uploaded for use on the robot 610.

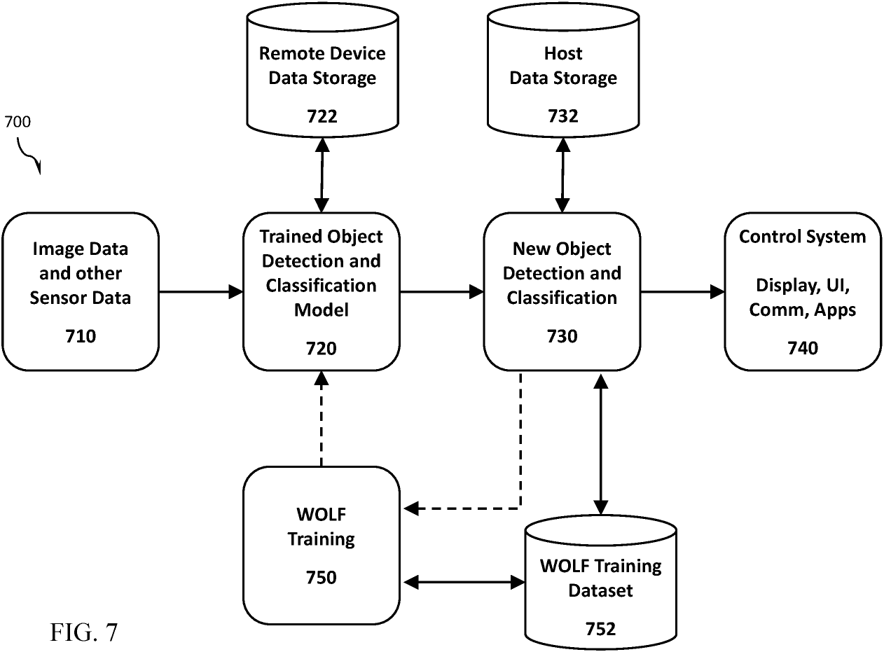

The operation of a WOLF object detection system will now be described in further detail with reference to FIG. 7, which illustrates an example system operation in accordance with one or more embodiments. A process 700 receives image and other sensor data 710 from one or more sensor systems of a remote device, such as a UAV, a UGV, an unmanned marine vehicle, or other remote device that includes a sensor for acquiring environmental data, and a processing component for detecting objects in the sensor data. The remote device processing components include a trained object detection and classification model 720 configured to receive image data (and optionally other sensor data) and output bounding boxes for detected objects, object classifications, and/or a classification confidence factor. In some embodiments, the trained object detection and classification model 720 includes a convolutional neural network trained on a training dataset 752 to detect, classify and locate objects in the sensor data. The trained object classification model 720 includes pretrained object detection and classification processing and trainable WOLF object detection and classification. The trained object detection and classification model 720 may further include sensor data processing components for one or more of the sensors such as image processing algorithms, radar data processing algorithms, Lidar processing algorithms, and/or other sensor data processing algorithms.

The remote device is configured to store image data, map data, user interest data and/or other data in a remote device data storage 722. In one embodiment, the remote device is configured to detect when communications with the controller system are lost and store data for use when communications are restored. This data may include an identification of object detections and data acquired or produced during the period without communications, addition data collection such pictures and video of the scene preceding, during and after detection, and other data.

During operation, the new object detection and classification process 730 identifies objects of interest to the user that cannot be classified by the trained object detection and classification model 720. For example, the trained detection and classification model 720 may be pre-trained to detect and classify certain identified objects, but the remote device may encounter new objects in the field that are of interest to the user. The user interface may include a display and control over video of the detection, including forward, reverse, pause, zoom, and other video controls as known in the art. The user interface may also display a map and/or other data constructed by the remote device. The data may be forwarded to and stored in a host data storage 732, which may include one or more of a local storage device, a networked storage device, or a cloud storage device.

After images containing new objects of interest to the user the image data, including bounding boxes and other object data as available, may be formatted for use in a WOLF training dataset 752. In a WOLF training process 750, the control system is configured to update trainable object detection and classification parameters of the trained object detection and classification model using the WOLF training dataset 752 and update the trainable parameters if certain criteria are met. In one embodiment, the performance of the updated WOLF model is tested using a test dataset derived from the collected image data, and the results are compared against the performance of the current trained model using the same dataset. The system may be configured, for example, to replace the trained object detection and classification model 720 if the performance of the updated model is above a certain threshold factor.

In the illustrated embodiment, the user may access the system using a control system 740, that includes a display, user interface, communications components, data processing applications and components, and user applications.

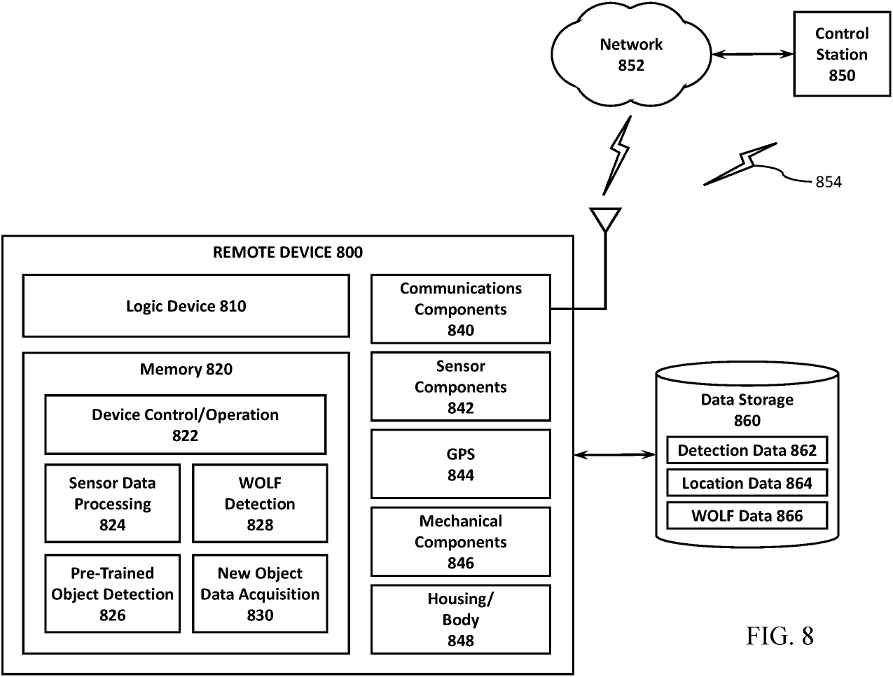

An example embodiment of a remote device will now be described with reference to FIG. 8. A remote device 800 is configured to communicate with a control station 850 (e.g., base station 230) over a wireless connection 854. The remote device 800 may be implemented as an unmanned vehicle, such as a UGV, UAV or UMV, or other device configured to acquire images of a scene for object detection and classification. In some embodiments, the user may control, interact and/or observe the activity of the remote device 800 through a user interface associated with the control station 850.

The remote device 800 includes a logic device 810, a memory 820, communications components 840, sensor components 842, GPS components 844, mechanical components 846, and a housing/body 848. Logic device 810 may include, for example, a microprocessor, a single-core processor, a multi-core processor, a microcontroller, a programmable logic device configured to perform processing operations, a digital signal processing (DSP) device, one or more memories for storing executable instructions (e.g., software, firmware, or other instructions), a graphics processing unit and/or any other appropriate combination of processing device and/or memory configured to execute instructions to perform any of the various operations described herein. Logic device 810 is adapted to interface and communicate with components 820, 830, 840, and 850 to perform method and processing steps as described herein.

It should be appreciated that processing operations and/or instructions may be integrated in software and/or hardware as part of logic device 810, or code (e.g., software or configuration data) which may be stored in memory 820. Embodiments of processing operations and/or instructions disclosed herein may be stored by a machine-readable medium in a non-transitory manner (e.g., a memory, a hard drive, a compact disk, a digital video disk, or a flash memory) to be executed by a computer (e.g., logic or processor-based system) to perform various methods disclosed herein.

Memory 820 includes, in one embodiment, one or more memory devices (e.g., one or more memories) to store data and information. The one or more memory devices may include various types of memory including volatile and non-volatile memory devices, such as RAM (Random Access Memory), ROM (Read-Only Memory), EEPROM (Electrically-Erasable Read-Only Memory), flash memory, or other types of memory.

In various embodiments, logic device 810 is adapted to execute software stored in memory 820 and/or a machine-readable medium to perform various methods, processes, and operations in a manner as described herein. The software includes device control and operation instructions 822 configured to control the operation of the remote device, such as autonomous driving, data acquisition, communications and control of various mechanical components 846 of the remote device 800. The software further includes sensor data processing logic 824 configured to receive captured data from one or more sensor components 842 and process the received data for further use by the remote device 800. For example, in various embodiments the sensor components 842 include image capture components and the sensor data processing logic 824 is configured to process received images. The software further includes pre-trained object detection models 826 configured to receive processed sensor data and output object detection and classification information that may include an object location and a confidence factor for the classification. In various embodiments, the pre-trained object detection logic 826 includes a trained neural network configured to receive an image, detect an object, generate a bounding box indicating a location of the object in the image, classify the object in accordance with predetermine classification categories, and generate a confidence score for the classification.

The memory 820 also stores software instructions for execution by the logic device 810 for wild object learning and finding detection and classification (e.g., WOLF detection logic 828), including new object learning and training, and new object data acquisition logic 830. The new object data acquisition logic 830 is configured to identify newly detected objects and store associated images and related data (e.g., bounding boxes). In some embodiments, the identification of a newly detected object includes processing an image through a pre-trained object detection logic 826 and/or WOLF detection logic and determining that classification for the object is not part of the trained system (e.g., a resulting classification with a confidence score below a threshold). In some embodiments, the identification of a newly detected object includes detecting a user action indicating an interest in the object (e.g., manual identification of an object, initiating an object tracking sequence, passage of an interval of time visualizing an object, etc.). In some embodiments, the pre-trained object detection logic 826 and the WOLF detection logic 828 are configured as a dual-task object detector as described herein with respect to FIGS. 1-5, including pre-trained parameters and learned WOLF parameters.

The memory 820 is further configured to store object detection data 862, location data 864 (e.g., map data), and WOLF data 866 used to implement the WOLF systems and methods described herein. In some embodiments, the remote device 800 includes a separate data storage component 860.

The sensor components 842 include a plurality of sensors configured to sense and capture information about the surrounding environment. The sensor components 842 include one or more image sensors for capturing visible spectrum and/or infrared spectrum images of a scene as digital data. Infrared sensors may include a plurality of infrared sensors (e.g., infrared detectors) implemented in an array or other fashion on a substrate. For example, in one embodiment, infrared sensors may be implemented as a focal plane array (FPA). Infrared sensors may be configured to detect infrared radiation (e.g., infrared energy) from a target scene including, for example, mid wave infrared wave bands (MWIR), long wave infrared wave bands (LWIR), and/or other thermal imaging bands as may be desired in particular implementations. Infrared sensors may be implemented, for example, as microbolometers or other types of thermal imaging infrared sensors arranged in any desired array pattern to provide a plurality of pixels.

The sensor components 842 may further include other sensors capable of sensing characteristics of one or more objects in the environment, such as a radar system, a Lidar system, or other sensor system. Radar and/or Lidar systems are configured to emit a series of pulses or other signals into the scene and detect pulses/signals that are reflected back off of objects in the scene. The components produce signal data representing objects in the scene and corresponding sensor data processing logic 824 is configured to analyze the signal data to identify the location of objects within the scene. Logic device 810 may be adapted to receive captured sensor data from one or more sensors, process captured signals, store sensor data in memory 820, and/or retrieve stored image signals from memory 820.

The communications components 840 include an antenna and circuitry for communicating with other devices using one or more wireless communications protocols. The communication components 840 may be implemented as a network interface component adapted for communication with a network 852, which may include a single network or a combination of multiple networks, and may include a wired or wireless network, including a wireless local area network, a wide area network, a cellular network, the Internet, a cloud network service, and/or other appropriate types of communication networks. The communications components 840 are also configured for direct wireless communications with the control station 850 using one or more wireless communications protocols such as radio control, Bluetooth, WiFi, Micro Air Vehicle Link (MAVLink), and other wireless communications protocols.

GPS 844 may be implemented as a global positioning satellite receiver, a global navigation satellite system (GNSS) receiver, and/or other device capable of determining an absolute and/or relative position of the remote device 800 based on wireless signals received from space-born and/or terrestrial sources, for example, and capable of providing such measurements as sensor signals. In some embodiments, GPS 844 may be adapted to determine and/or estimate a velocity of remote device 800 (e.g., using a time series of position measurements).

The mechanical components 846 include motors, gears, wheels/tires, tracks and other components for moving remote control across the terrain and/or operating physical components of the remote device 800. In various embodiments, one or more of the mechanical components 846 are configured to operate in response to instructions from logic device 810. The remote device 800 includes a housing 848 that protects the various components of remote device 800 from environmental or other conditions as desired.

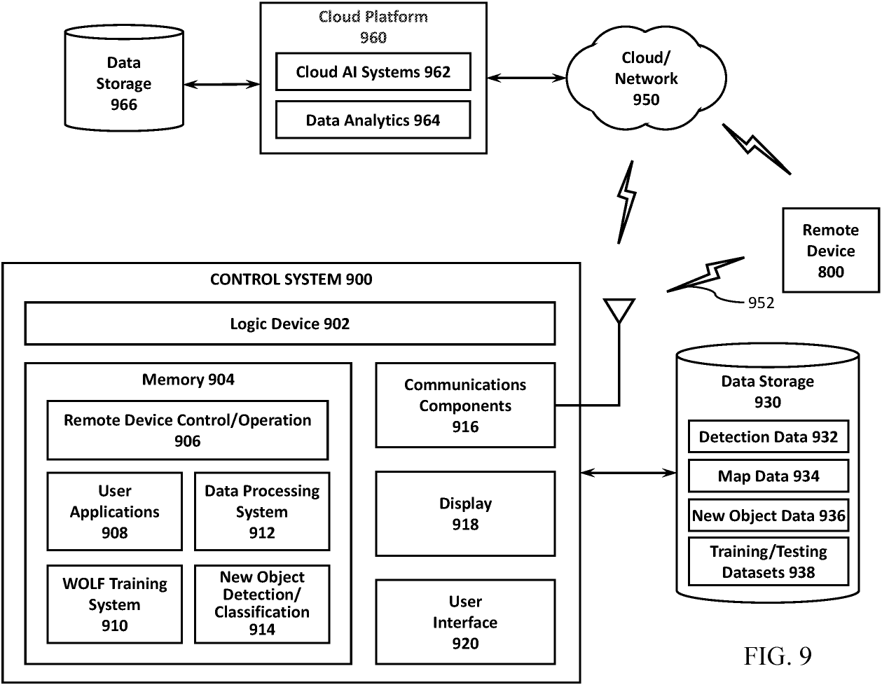

An example base station/control system for use with remote device 800 will now be described with reference to FIG. 9. A control system 900 is configured to communicate with remote device 800 across a wireless communications link 952, and/or through a network, such as cloud/network 950, to interface with the remote device 800. In the illustrated embodiment, the control system 900 includes a logic device 902, a memory 904, communications components 916, display 918 and user interface 920.

The logic device 902 may include, for example, a microprocessor, a single-core processor, a multi-core processor, a microcontroller, a programmable logic device configured to perform processing operations, a DSP device, one or more memories for storing executable instructions (e.g., software, firmware, or other instructions), a graphics processing unit and/or any other appropriate combination of processing device and/or memory configured to execute instructions to perform any of the various operations described herein. Logic device 902 is adapted to interface and communicate with various components of the controller system including the memory 904, communications components 916, display 918 and user interface 920.

Communications components 916 may include wired and wireless interfaces. Wired interfaces may include communications links with the remote device 800, and may be implemented as one or more physical network or device connect interfaces. Wireless interfaces may be implemented as one or more WiFi, Bluetooth, cellular, infrared, radio, MAVLink, and/or other types of network interfaces for wireless communications. The communications components 916 may include an antenna for communications with the remote device during operation.

Display 918 may include an image display device (e.g., a liquid crystal display (LCD)) or various other types of generally known video displays or monitors. Under interface 920 may include, in various embodiments, a user input and/or interface device, such as a keyboard, a control panel unit, a graphical user interface, or other user input/output. The display 918 may operate as both a user input device and a display device, such as, for example, a touch screen device adapted to receive input signals from a user touching different parts of the display screen.

The memory 904 stores program instructions for execution by the logic device 902 including remote device control/operation instructions 906, user applications 908, a WOLF training system 910, data processing system 912, and new object detection/classification applications 914. Data used by the control system 900 may be stored in the memory 904 and/or stored in a separate data storage 930. In some embodiments, the data storage may include detection data 932, map data 934 for controlling the remote device, new object detection data 936, and training/testing datasets 938. The remote device control and operation instructions 906 facilitate operation of the control system 900 and interface with the remote device 800, including sending and receiving data such as receiving and displaying a real-time video feed from an image sensor of the remote device 800, transmitting control instructions to the remote device, and other operations desired for a particular implementation. The user applications 908 include system configuration applications, data access and display applications, remote device mission planning applications, and other desired user applications.

The WOLF training system 910 is configured to generate trained, dual-task neural network models for implementation on the remote device 800 and the control system 900. In some embodiments, one or more aspects of the WOLF training system 910 may be implemented through a remote processing system, such as a cloud platform 960, that includes cloud AI systems 962, data analytics 964 modules, and data storage 966. In some embodiments, the cloud platform 960 is configured to perform one or more functions of the control system 900 as described herein. The data processing system 912 is configured to perform processing of data captured by the remote device 800, including viewing, annotating, editing and configuring map information generated by the remote device 800.

The new object detection/classification application 914 is configured to manage new object detection data for use with the WOLF training system 910 to generate improved neural network models. In some embodiments, the new object detection/classification application 914 includes processes for accessing object detection data and user interest data from the remote device 800 and facilitating an interactive display providing the user with a visual representation of the object detection data for user input and control. The user may control the display to focus on desired aspects of the object and/or object detection data and input confirmation on object classification, refinement of object classification data (e.g., manual adjusting object location, manually identifying a point of interest on the object, etc.) and corrections to object classification data as desired. In some embodiments, the new object detection/classification applications 914 are configured to automatically identify new objects of interest to the user, train the dual-task object detection system and reconfigure the remote device for detection and classification of the new objects.

In some embodiments, the WOLF training system 910 is further configured to generate labeled training data representing the new objects. The WOLF training system 910 may be further configured to compare training results with and without the learned parameters to confirm an acceptable accuracy of the new model. If the accuracy of the model is determined to be improved by including of the new training data, then the new training data is added to the training dataset and the WOLF training system 910 generates an updated training model to replace the object detection model implemented by the remote device 800.

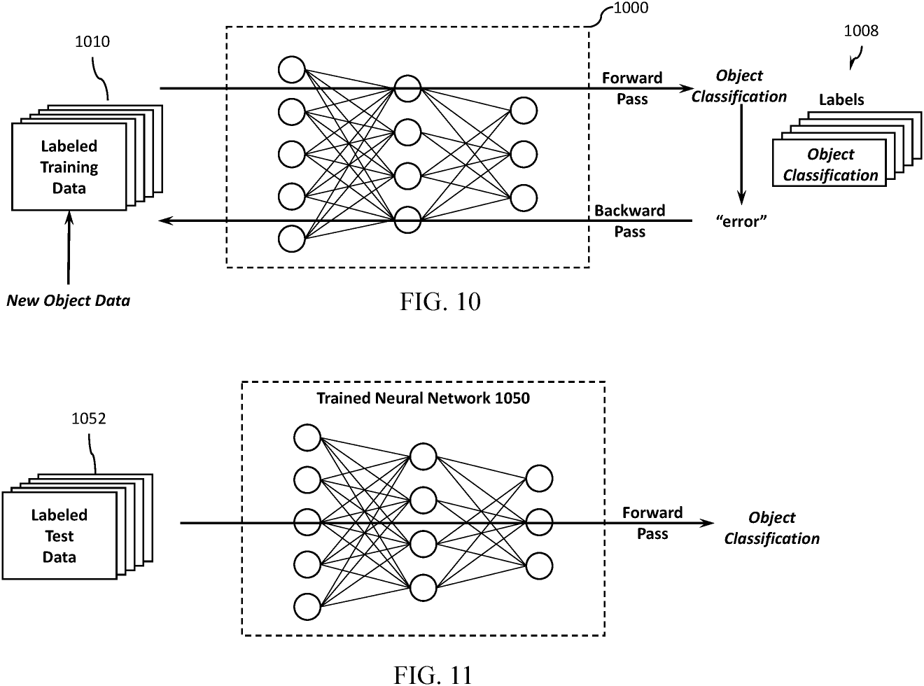

Referring to FIG. 10, an example a neural network that may be used to generate trained models will be described, in accordance with one or more embodiments. The neural network 1000 is implemented as a convolutional neural network (CNN) that receives a labeled training dataset 1010 to produce object detection information 1008 for each data sample. The training dataset represents captured sensor data associate with one or more types of sensors, such as infrared images, visible light images, radar signal data, Lidar signal data, GPS data, and/or other data used by the remote device 800. For object classification in images, the images may comprise a region of interest from a captured image that includes an object to be identified.

The training includes a forward pass through the neural network 1000 to produce object detection and classification information, such as an object location, an object classification, and a confidence factor in the object classification. Each data sample is labeled with the correct classification and the output of the neural network 1000 is compared to the correct label. If the neural network 1000 mislabels the input data, then a backward pass through the neural network 1000 may be used to adjust the neural network to correct for the misclassification. The neural network 1000 includes pre-trained parameters that are adjusted when training the neural network 1000 for pre-defined object detection and classification tasks. The neural network 1000 also includes WOLF parameters, which are adjusted when the neural network 1000 is trained for new object detection and classification during operation.

Referring to FIG. 11, a trained neural network 1050, may then be tested for accuracy using a set of labeled test data 1052. The trained neural network 1050 may then be implemented in a run time environment of the remote device to detect and classify objects.

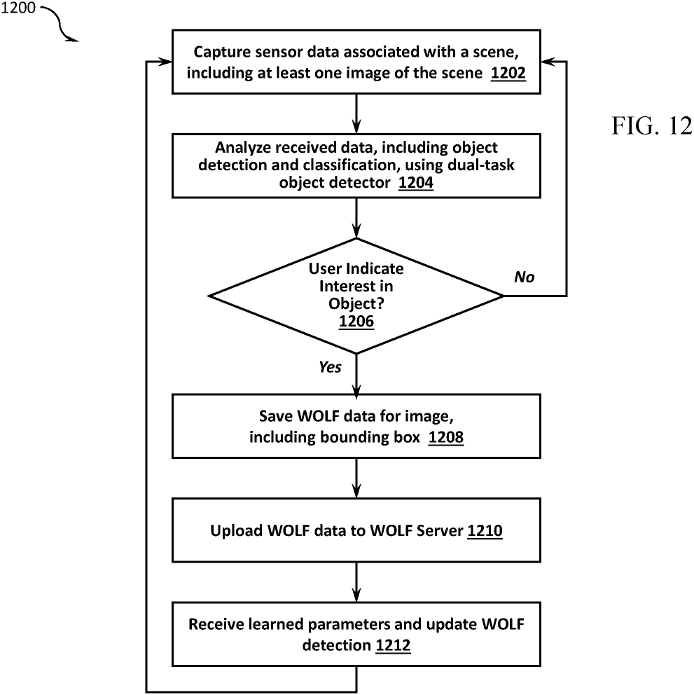

Referring to FIG. 12, an example operation of a WOLF object detection and classification system in a remote device will now be described, in accordance with one or more embodiments. An object detection and classification process 1200 starts by capturing sensor data associated with a scene, in step 1202. The data includes at least one image of all or part of the scene to facilitate object detection and classification. Next, in step 1204, the system analyzes the received data, including object detection and classification, using a dual-task object detector (e.g., the dual-task object detector illustrated in FIG. 4).

In step 1206, the system determines whether the user has indicated an interest in a detected object. In one embodiment, the remote device is a UAV and the user interest is determined by initiation of a user designated target tracking process. In other embodiments, user interest may be determined by manual identification of by the user of an object in an image, presence of a detected object in the user’s field of view for an interval of time, by satisfaction of user selected criteria for an object (e.g., object in size range, moving on a road, etc.), or other criteria appropriate for the user environment. If there is no determined user interest of an object, then processing of the image stream continues.

If the system determines that there is user interest in a detected object, then WOLF data for the image is stored in step 1208. In some embodiments, the system automatically stores images with bounding boxes when the user indication is determined. In some embodiments, the system applies additional criteria to determine the relevance of the images to WOLF detection. For example, the system may determine relevance by comparing an object classification and confidence score from step 1204 to relevance criteria. In some embodiments, if the object is not assigned a known classification and/or if the confidence score of the classification is below a relevance threshold, then the object is relevant to WOLF detection and the images are stored to facilitate training of the WOLF detection to classify the new object.

In step 1210, the WOLF data is uploaded to the WOLF server. In various embodiments, the WOLF server may be implemented on the remote device, at a base station, at a networked computer system, by cloud server, or other processing system. In step 1212, the remote device receives learned parameters and updates the WOLF detection parameters to facilitate classification of the new object class. In some embodiments, the object detection and classification process is implemented as a dual-task object detector, including pre-trained classifications with fixed parameters and WOLF trained classifications, with learned parameters that are updated in step 1212. In some embodiments, the new classification is provided with a generic object class name until the user defines the new class.

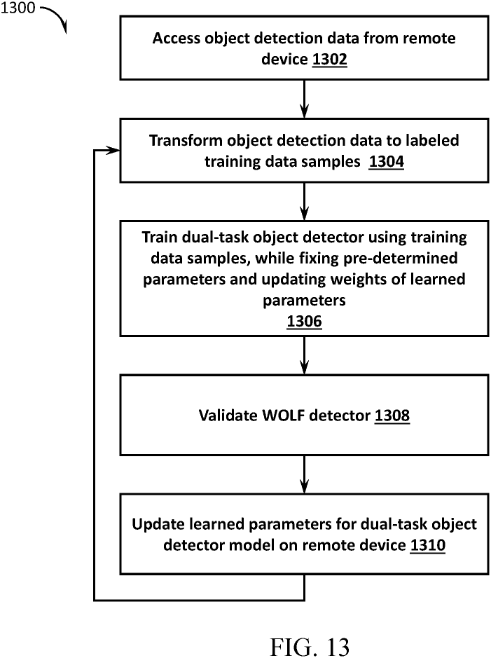

Referring to FIG. 13, an example operation of object detection and classification in a control system comprising a WOLF server will now be described, in accordance with one or more embodiments. A WOLF training process 1300 starts by accessing object detection data received from the remote device, in step 1302. This step may take place during a time when the remote device is in range for communications, when the remote device returns home and is attached to a docking station, through a network, or through another method. In some embodiments, the received object detection data includes images and bounding boxes for detected objects. In some embodiments, the received object detection data is associated with user indicated interest in a detected object. In various embodiments, the received detection data is received from one or more remote devices and comprises one or more new object classifications.

In step 1304, the WOLF training process transforms the object detection data to labeled training data samples. In some embodiments, the object detection data is labeled as a new object classification. In some embodiments, the object detection data includes batches of images, each batch representing a different indication of user interest. For example, during operation of a remote device, the user may track a first object, then a second object, and subsequent objects, with each object tracking operation associated with a batch of images and object detections.

In step 1306, the WOLF training process trains the dual-task object detector using the training data samples. In one embodiment, the dual-task object detector includes a pre-trained task having fixed parameters for detecting and classifying pre-determined object classes, and a WOLF detection task having updatable parameters that are learned through the WOLF training process for detecting and classifying new, learned object classes. The WOLF training process updates the weights of learned parameters to reduce the error in the classification of the new object classes.

In step 1308, the WOLF training system validates the updated WOLF detector. In one embodiment, the WOLF detector compares classification results against an existing trained model and updates the WOLF parameters if better performance is determined. In some embodiments, the WOLF training system includes a plurality of WOLF classifications representing new object classifications and assigns WOLF labels associated with the WOLF classifications to the object detection data. In some embodiments, the assignment of a particular WOLF label to an object training data sample is learned through the WOLF training process. In some embodiments, the WOLF labels are assigned and/or reassigned based at least in part on a similarity to and/or confidence score associated with one or more WOLF classifications. In some embodiments, the WOLF training system analyzes whether training data samples will improve or reduce the accuracy of the trained object detection model, and removes training data samples from the WOLF training dataset that reduce the accuracy of the trained model.

In step 1310, the WOLF server uploads the learned parameters for the dual-task object detector model to the remote device to update the WOLF classification task to detect and classify the learned object classes.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A system comprising:
a detection device logic configured to:
detect and classify an object in sensor data comprising at least one image using a dual-task classification model comprising pre-determined object classifications and learned object classifications;
determine user interest in the detected object;
communicate object detection information to a control system based at least in part on the determined user interest in the detected object;
receive learned object classification parameters based at least in part on the communicated object detection information; and
update the dual-task classification model with the received learned object classification parameters.

2. The system of claim 1, wherein the detection device comprises an unmanned ground vehicle (UGV), and unmanned aerial vehicle (UAV), and/or an unmanned marine vehicle (UMV).

3. The system of claim 1, wherein the detection device further comprises a sensor configured to generate the sensor data, the sensor comprising a visible light image sensor, an infrared image sensor, a radar sensor, and/or a Lidar sensor.

4. The system of claim 1, wherein the detection device logic is further configured to execute a trained neural network configured to receive a portion of the sensor data and output a bounding box for a detected object and an object classification.

5. The system of claim 4, wherein the trained neural network is configured to generate a confidence factor associated with the classification.

6. The system of claim 1, further comprising the control system comprising:
a second logic device configured to:
receive object detection information from the detection device;
train the dual-task model to classify the received object detection information; and
transmit learned object classification parameters to the detection device.

7. The system of claim 6, wherein the second logic device is further configured to generate a labeled training data sample from the object detection information for use in training the dual-task model.

8. The system of claim 6, wherein the second logic device is further configured to retrain the dual-task model using a dataset that includes the labeled training data sample and determine whether to replace a trained object classifier with the retrained dual-task model based at least in part on a comparative accuracy of the models.

9. The system of claim 1, wherein the detection device logic is further configured to construct a map based on generated sensor data.

10. The system of claim 1, wherein the detection device comprises an unmanned vehicle adapted to track an object in accordance with user instructions, and wherein determine user interest in the detected object comprises determining whether the user has instructed the unmanned vehicle to track the object.

11. A method comprising:
operating a detection device;
detecting and classifying an object in sensor data comprising at least one image using a dual-task classification model comprising pre-determined object classifications and learned object classifications;
determining user interest in the detected object;
communicating object detection information to a control system based at least in part on the determined user interest in the detected object;
receiving learned object classification parameters based at least in part on the communicated object detection information; and
updating the dual-task classification model with the received learned object classification parameters.

12. The method of claim 11, wherein the detection device comprises an unmanned ground vehicle (UGV), and unmanned aerial vehicle (UAV), and/or an unmanned marine vehicle (UMV).

13. The method of claim 11, further comprising generating the sensor data comprising a visible light image, an infrared image, a radar signal, and/or a Lidar signal.

14. The method of claim 11, wherein the method further comprises operating a trained neural network configured to receive a portion of the sensor data and output a bounding box for a detected object and an object classification.

15. The method of claim 14, wherein the neural network is configured to generate a confidence factor associated with the classification.

16. The method of claim 11, further comprising operating a control system to:
receive object detection information from the detection device;
train the dual-task model to classify the received object detection information; and
transmit learned object classification parameters to the detection device.

17. The method of claim 16, further comprising generating a training data sample from the object detection information for use in training an object classifier.

18. The method of claim 17, further comprising retraining the object classifier using a dataset that includes the training data sample;
determining whether to replace a trained object classifier with the retrained object classifier, determination based at least in part on a comparative accuracy of the trained object classifier and the retrained object classifier in classifying a test dataset.

19. The method of claim 18, further comprising, if it is determined to replace the trained object classifier with the retrained object classifier, downloading the retrained object classifier to the detection device to replace the trained object classifier; and adding the training data sample to the training dataset.

20. The method of claim 11, wherein the detection device is an unmanned vehicle, and wherein the operating the detection device further comprises operating the unmanned vehicle to traverse a search area and generate sensor data associated with one or more objects that may be present in the search area.
